(19) United States
(12) Patent Application Publication
(10) Pub. No.: US 2004/0037503 A1
(43) Pub. Date: Feb. 26, 2004

(54) Optical waveguide with non-uniform sidewall gratings

(76) Inventors: Jeffrey T. Hastings, Lexington, KY (US); Michael H. Lim, Cambridge, MA (US); Henry I. Smith, Sudbury, MA (US)

Correspondence Address: Samuels, Gauthier & Stevens LLP, Suite 3300, 225 Franklin Street, Boston, MA, 02110, US

(21) Appl. No.: 10/446,245

(22) Filed: May 28, 2003

Related U.S. Application Data
(60) Provisional application No. 60/384,288, filed on May 30, 2002.

(51) Int. Cl. G02B 6/34; G02B 6/10

(52) U.S. Cl. 385/37; 385/130

(57) ABSTRACT

A diffraction grating of non-uniform strength is introduced into an optical waveguide by modulating its width. The waveguide may be fabricated using one of several planar processing techniques. Varying the size, position, and/or thickness of the grating teeth provides the desired variation of grating strength. Certain functional variations of grating strength suppress side-lobe levels in the grating reflection and transmission spectra. This process, termed apodization, is necessary for precise wavelength filtering and dispersion compensation. If desired, different periodicity gratings can be introduced in each side of the waveguide, multiple periodicities can be superimposed, the grating can be angled with respect to the waveguide, and the grating period and phase can be varied.

### PRIORITY INFORMATION

The present patent application claims priority under 35 U.S.C. §119 from U.S. Provisional Patent Application Serial No. 60/384,288 filed on May 30, 2002. The entire contents of U.S. Provisional Patent Application Serial No. 60/384,288 filed on May 30, 2002 are hereby incorporated by reference.

### FIELD OF THE PRESENT INVENTION

The present invention is directed to optical waveguides with non-uniform grating structures formed by varying the width of the waveguide. More particularly, the present invention is directed to a process and methodology of lithographically fabricating the waveguides and grating structures.

### BACKGROUND OF THE PRESENT INVENTION

Conventionally, optical data transmission has been used to meet the demand of high-bandwidth, long-distance communications. As these communications networks grow in complexity, the networks will increasingly rely on compact, integrated, and manufacturable components that manipulate signals in the optical domain. Diffractive structures provide powerful tools to control light. Not surprisingly, many of the conventional optical communications components require gratings or periodic physical corrugations in dielectric or semiconductor waveguides. These components include distributed feedback (DFB) and distributed-Bragg-reflector (DBR) lasers, gain equalization filters, dispersion compensators, wavelength-division-multiplexing (WDM) channel add/drop filters, and other diffractive elements. Typically, the waveguide and grating are fabricated in separate steps of a planar process similar to that used in the semiconductor industry.

These conventional optical waveguides, formed by a conventional planar process, are typically formed by deposition of a higher refractive-index core material on a lower refractive-index material, followed by lithographic definition and etching of the higher-index material. Finally a lower refractive-index cladding layer may be deposited over the higher-index waveguide core, if necessary.

Variations to this process may include patterning the lower-cladding layer or upper-cladding layer instead of the core layer, selective epitaxial growth of the core, photo-induced refractive-index alteration, and/or implantation or thermal diffusion of dopants. These conventional approaches produce a variety of optical waveguide geometries most often described as channel, rib, ridge, and strip waveguides.

Many conventional integrated-optical devices include uniform gratings, periodic modulation of refractive index or physical structure, which are formed in or adjacent to the optical waveguides. Such structures are useful for wavelength filtering, compensating fiber-induced dispersion, feedback for laser devices, gain equalization, coupling between waveguides, coupling between the modes of a single waveguide, and coupling light out of and into waveguides.

For most planar devices the uniform grating is formed in a separate lithographic step from the waveguide core and is placed in either the top or bottom of the core material. The most common of these devices is the distributed-feedback laser.

On the other hand, for many optical devices, the flexibility and performance of uniform gratings are insufficient. For example, the side-lobes in the reflection spectrum of a uniform grating prohibit selectively filtering a single channel from the spectrum used in wavelength-division-multiplexing (WDM). When using chirped gratings to compensate for fiber-induced dispersion, gratings of uniform strength introduce undesirable ripples in the group-delay spectrum.

To compensate for these unwanted effects, it has been found that the gradual increasing and then decreasing of the grating strength along the length of the grating, a process called apodization, provides some minimization of these unwanted effects.

Conventional apodized grating are most often realized by photo-induced refractive-index changes in optical fiber. In addition, apodized gratings, having varied duty cycle, are conventionally placed in the top of channel waveguides.

Placing the grating in the top or bottom of the waveguide presents several disadvantages, particularly if the grating is an apodized grating. First, the structure requires at least two lithography and etching steps, one for the waveguide core and another for the grating. Moreover, to introduce apodization the fabrication process must vary the etch-depth, duty-cycle, or grating overlap with the waveguide core. Varied etch depths are difficult to achieve and control in planar processing.

Thirdly, if the duty-cycle, the ratio of grating tooth to grating space, is varied, the finest feature that can be patterned limits the minimum obtainable grating strength. Finally, varying the grating overlap with the core region requires precise alignment between the grating and waveguide lithographic steps.

To address these disadvantages, it has been found that if the grating is placed in the sidewalls of the waveguide, the fabrication process can define the core and grating regions in the same lithographic step. Examples of conventional optical waveguides having uniform gratings placed in the sidewalls of the optical waveguide are disclosed in U.S. Pat. No. 5,930,437 to Nakai et al. and U.S. Pat. No. 5,659,640 to Joyner, as well as, illustrated in FIGS. 1 and 2 of the present application. The entire contents of U.S. Pat. Nos. 5,930,437 and 5,659,640 are hereby incorporated by reference.

As illustrated in FIG. 1, an optical waveguide filter is a planar optical waveguide, in which a core 12 is provided along a substrate 10 is enclosed by a cladding 14 to form an optical waveguide. Core 12 is configured in such a manner that the width periodically changes in beam propagating direction 16, thus forming a grating structure. Core 12 comprises a main stem 12A which is formed on substrate 10, linearly extending in the beam propagating direction 16 and short branches 12B with a certain length which extend perpendicularly to the beam propagating direction 16 toward both sides along the plane of the substrate and are arranged at regular intervals in the beam propagating direction 16 to form a uniform grating. Thus, branches 12B are arranged to form a ladder-shaped geometry when it is viewed from the top, forming a rectangular waveform arrangement.

Moreover, as illustrated in FIG. 2, an exemplary buried heterostructure waveguide 20 includes a substrate 21 on which a buffer layer 24 is fabricated. A multiple quantum well (MQW) stack 26 serving as the waveguide core is formed on the layer 24. The MQW stack 26 is buried in a cladding layer 51. An optical grating 27 is formed within the MQW stack 26. An active device 40 also may be fabricated on the substrate 21.

As described above, conventional uniform grating have been fabricated in the sidewalls of the optical waveguides to avoid the disadvantages associated with the gratings formed on the top or the bottom of the optical waveguide. However, as noted above, for many optical devices, the flexibility and performance of uniform gratings are insufficient.

Therefore, it is desirable to provide an optical waveguide that has a non-uniform grating wherein the non-uniform grating is placed in one or both sidewalls of the optical waveguide. Moreover, it is desirable to provide a technique for fabricating the non-uniform grating on one or both sides of the waveguide in one lithographic step. Lastly, it is desirable to provide a technique for controlling the grating strength (a function of the grating depth) along the length of the grating, a feature essential for high-quality filters and dispersion compensators.

### SUMMARY OF THE PRESENT INVENTION

A first aspect of the present invention is directed to an integrated optical device. The integrated optical device includes a substrate and a waveguide formed on the substrate. The waveguide has a width that varies non-uniformly along a direction of light propagation.

A second aspect of the present invention is directed to a wavelength selective filter that includes a waveguide having a width that varies non-uniformly along a direction of light propagation.

A third aspect of the present invention is directed to a pulse shape-matching filter that includes a waveguide having a width that varies non-uniformly along a direction of light propagation.

A fourth aspect of the present invention is directed to a dispersion compensator that includes a waveguide having a width that varies non-uniformly along a direction of light propagation.

A fifth aspect of the present invention is directed to a laser feedback structure that includes a waveguide having a width that varies non-uniformly along a direction of light propagation.

A sixth aspect of the present invention is directed to an optical detector that includes a waveguide having a width that varies non-uniformly along a direction of light propagation.

A seventh aspect of the present invention is directed to a waveguide-to-waveguide coupler that includes a waveguide having a width that varies non-uniformly along a direction of light propagation.

A further aspect of the present invention is directed to a waveguide-mode coupler that includes a waveguide having a width that varies non-uniformly along a direction of light propagation.

Another aspect of the present invention is directed to a waveguide-to-radiation coupler that includes a waveguide having a width that varies non-uniformly along a direction of light propagation.

A further aspect of the present invention is directed to a method of forming an optical waveguide having a width that non-uniformly varies along a direction of propagation. The method deposits optical waveguide material on a substrate; creates a mask having a pattern containing a central waveguide-region and adjacent grating teeth, the adjacent grating teeth providing non-uniform varying width of the optical waveguide; and etches away the optical waveguide material not protected by the mask.

Another aspect of the present invention is a method of forming an optical waveguide having a width that non-uniformly varies along a direction of propagation. The method deposits optical waveguide material on a substrate; creates a mask having a pattern containing a central waveguide-region and adjacent grating teeth, the adjacent grating teeth providing non-uniform varying width of the optical waveguide; and etches away a portion of the optical waveguide material not protected by the mask so as to form a rib waveguide.

A further aspect of the present invention is directed to a method of forming an optical waveguide having a width that non-uniformly varies along a direction of propagation. The method deposits photon, electron, ion, or neutral atom sensitive core materials on a substrate and exposes the deposited material to the appropriate radiation or particle in a pattern containing a central waveguide-region and adjacent grating teeth, the adjacent grating teeth providing non-uniform varying width of the optical waveguide.

Another aspect of the present invention is directed to a method of forming an optical waveguide having a width that non-uniformly varies along a direction of propagation. The method deposits photon, electron, ion, or neutral atom sensitive core materials on a substrate and exposes the deposited material to the appropriate radiation or particle in a pattern containing a central waveguide-region and adjacent grating teeth, the adjacent grating teeth providing non-uniform varying width of the optical waveguide to alter the refractive index of the deposited material.

A further aspect of the present invention is directed to a method of forming an optical waveguide having a width that non-uniformly varies along a direction of propagation. The method deposits photon, electron, ion, or neutral atom sensitive core materials on a substrate; creates a the pattern containing a central waveguide-region and adjacent grating teeth, the adjacent grating teeth providing non-uniform varying width of the optical waveguide in a dopant material; and diffuses the patterned dopant into the deposited material.

### BRIEF DESCRIPTION OF THE DRAWINGS

The present invention may take form in various components and arrangements of components, and in various steps and arrangements of steps. The drawings are only for purposes of illustrating a preferred embodiment or embodiments and are not to be construed as limiting the present invention, wherein:

FIGS. 1 and 2 illustrate conventional optical waveguides with uniform gratings placed in the sidewalls of the optical waveguide;

FIG. 3 illustrates a channel waveguide with non-uniform sidewall gratings according to the concepts of the present invention;

FIG. 4 illustrates a rib waveguide with non-uniform sidewall gratings according to the concepts of the present invention;

FIGS. 5 through 9 illustrate variations of a channel waveguide with non-uniform sidewall gratings according to the concepts of the present invention;

FIG. 10 illustrates one embodiment of a waveguide with non-uniform sidewall gratings according to the concepts of the present invention;

FIG. 11 illustrates contours of constant grating strength, , and effective refractive index, η_{eff}, as a function of waveguide and grating width for the transverse-electric (TE) mode according to the concepts of the present invention;

FIG. 12 illustrates the extent and placement of the grating region as a function of position along the waveguide according to the concepts of the present invention;

FIG. 13 illustrates the calculated reflection spectrum for the waveguide's TE mode according to the concepts of the present invention;

FIG. 14 illustrates three scanning-electron micrographs at different points along a grating corresponding to different grating strengths according to the concepts of the present invention; and

FIG. 15 shows the measured transmission response of the grating according to the concepts of the present invention for the transverse-electric (TE) and transverse-magnetic (TM) modes compared to the transmission response of a similar-bandwidth device without apodization.

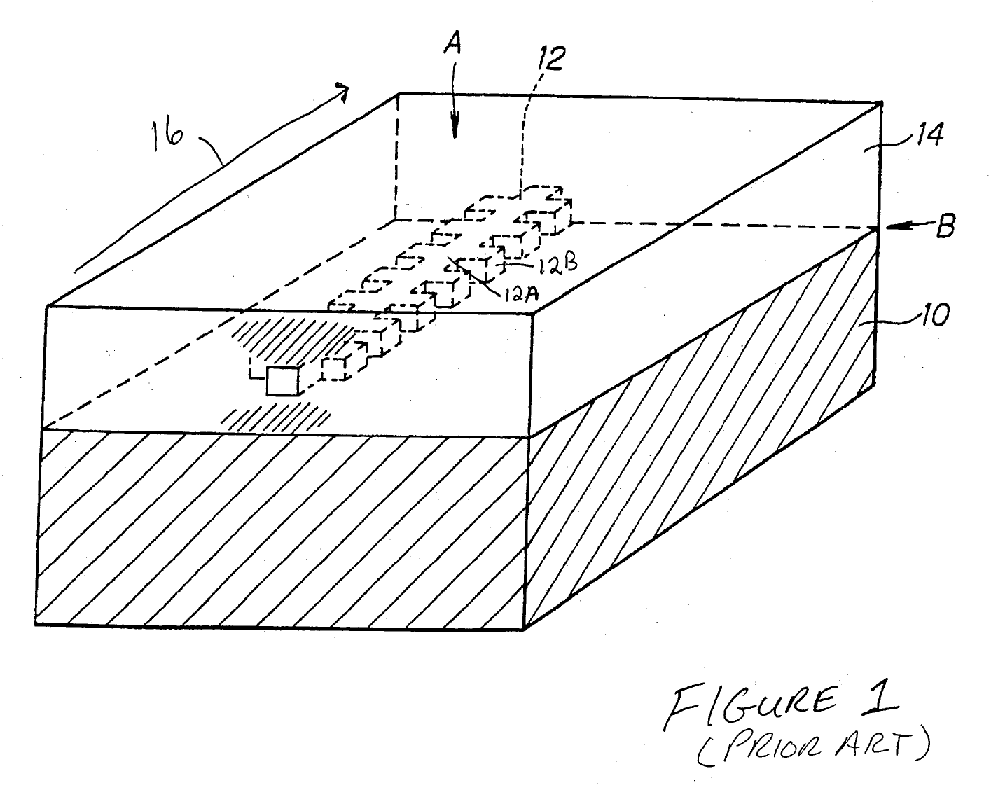

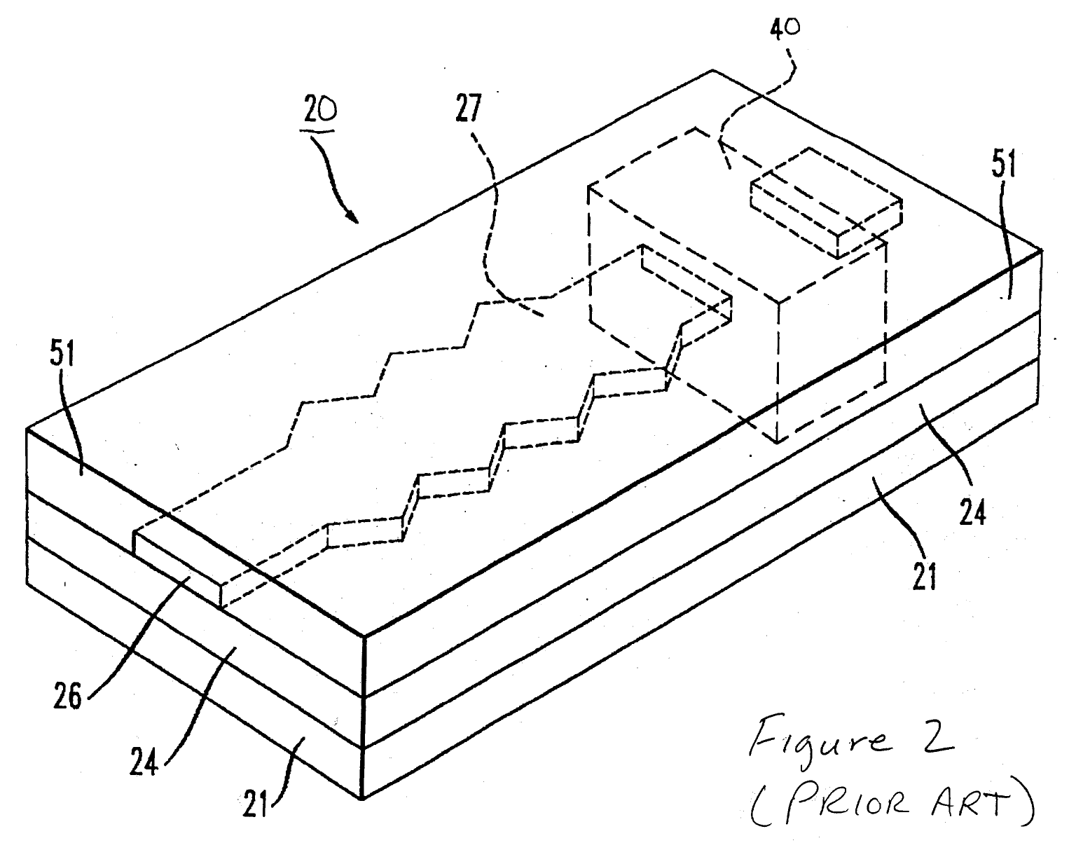

### DETAILED DESCRIPTION OF THE PRESENT INVENTION

The present invention will be described in connection with preferred embodiments; however, it will be understood that there is no intent to limit the present invention to the embodiments described herein. On the contrary, the intent is to cover all alternatives, modifications, and equivalents as may be included within the spirit and scope of the present invention as defined by the appended claims.

For a general understanding of the present invention, reference is made to the drawings. In the drawings, like reference numbering has been used throughout to designate identical or equivalent elements. It is also noted that the various drawings illustrating the present invention are not drawn to scale and that certain regions have been purposely drawn disproportionately so that the features and concepts of the present invention could be properly illustrated.

The present invention is directed to an optical device containing non-uniform gratings in an optical waveguide and a method for forming such a device. Ideally, the grating is placed in the sides of the waveguide during the same planar processing step used to form the guide itself. Such a device eliminates the various difficulties of placing non-uniform gratings in the top or bottom of a planar waveguide. As a result, higher performance devices can be realized in fewer fabrication steps.

More specifically, as will be seen from the detail description below, the present invention consists of a waveguide whose width is periodically modulated along the direction of light propagation, usually defined as z. The periodicity, , of the modulation is chosen to achieve a particular function. For example, to reflect a narrow band of wavelengths back along the same waveguide, the periodicity is given by the Bragg condition, =0/(2 η_{eff}), where 0 is the desired center reflection wavelength and η_{eff} is the waveguide's effective-refractive index. Such a device forms a narrow-band reflection filter. More complex filters and devices for dispersion compensation may also require , 0 and/or η_{eff} to vary along the direction of propagation. Other functions, such as grating-assisted coupling between waveguides, require substantially different periodicities.

Furthermore, the concepts of the present invention pertain to devices where the grating strength, often described by a coupling constant in units of inverse length, varies along z. This is accomplished by adjusting the width, position, and/or thickness of the grating teeth along the waveguide in the direction of propagation. These parameters also determine η_{eff}, and thus 0, and can be tailored such that 0 is constant, or varies in a desired manner.

For narrow-band reflection filters, it is desirable to suppress side lobes in the reflection spectrum, and this is accomplished though apodization. The apodization function, (z), is chosen such that the grating strength gradually increases from one end of the grating to the center, and then decreases toward the other end. It is often desirable to keep η_{eff}(z)constant while the grating strength changes. To choose the proper width, placement, and thickness of the grating teeth one must know and η_{eff} as a function of the waveguide and grating geometry. Then one can translate the desired functions (z) and η_{eff}(z) into a physical structure.

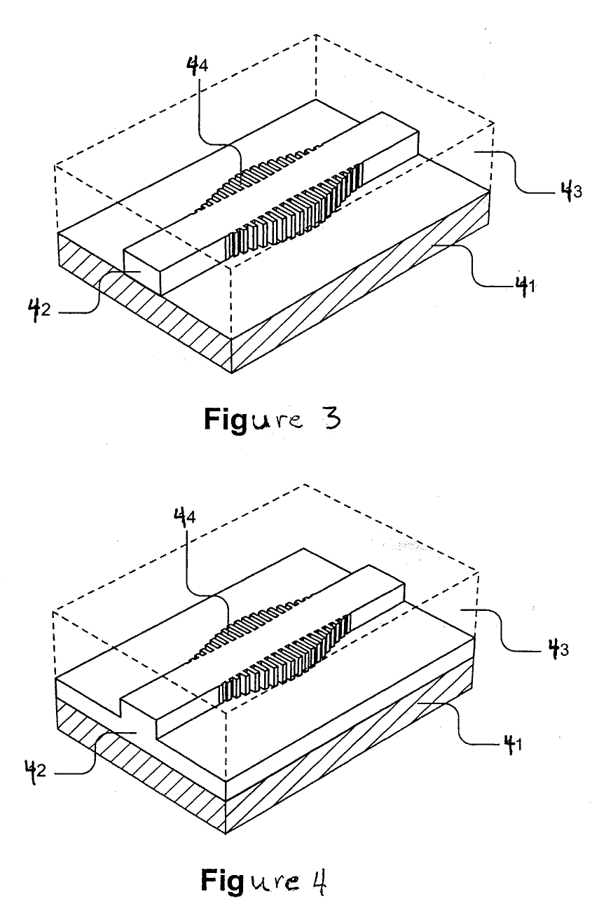

As noted above, it is desirable that an optical waveguide include a non-uniform grating wherein the non-uniform grating is placed in one or both of the sidewalls of the optical waveguide. FIGS. 3 and 4 illustrate examples of such optical waveguides according to the concepts of the present invention.

As shown in FIG. 3, the optical waveguide is a channel optical waveguide that includes a channel shaped silicon region 42 with non-uniform sidewall gratings 44 formed upon a silicon-dioxide layer 41. The variation of the grating width is representative of an apodized reflection filter as described above. The optical waveguide of FIG. 3 further includes an upper cladding layer 43. However, it is noted that the optical waveguide may be designed such that the upper cladding is air or a vacuum.

It is further noted that only a few grating teeth are shown for illustrative purposes, but many useful devices contain thousands of grating teeth. It is also important to note that the grating teeth can extend both into and out-from the original waveguide.

As shown in FIG. 4, the optical waveguide is a rib optical waveguide that includes a rib shaped silicon region 42 with non-uniform sidewall gratings 44 formed upon a silicon-dioxide layer 41. As in FIG. 3, the variation of the grating width is representative of an apodized reflection filter. The optical waveguide of FIG. 4 further includes an upper cladding layer 43. However, it is noted that the optical waveguide may be designed such that the upper cladding is air or a vacuum.

It is further noted that only a few grating teeth are shown for illustrative purposes, but many useful devices contain thousands of grating teeth. It is also important to note that the grating teeth can extend both into and out-from the original waveguide.

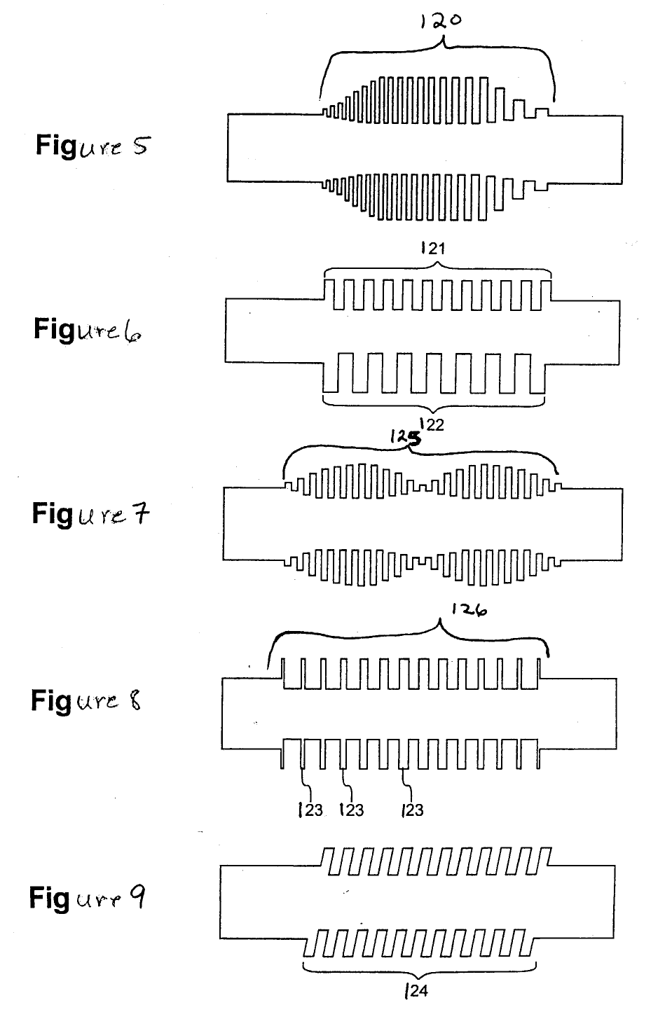

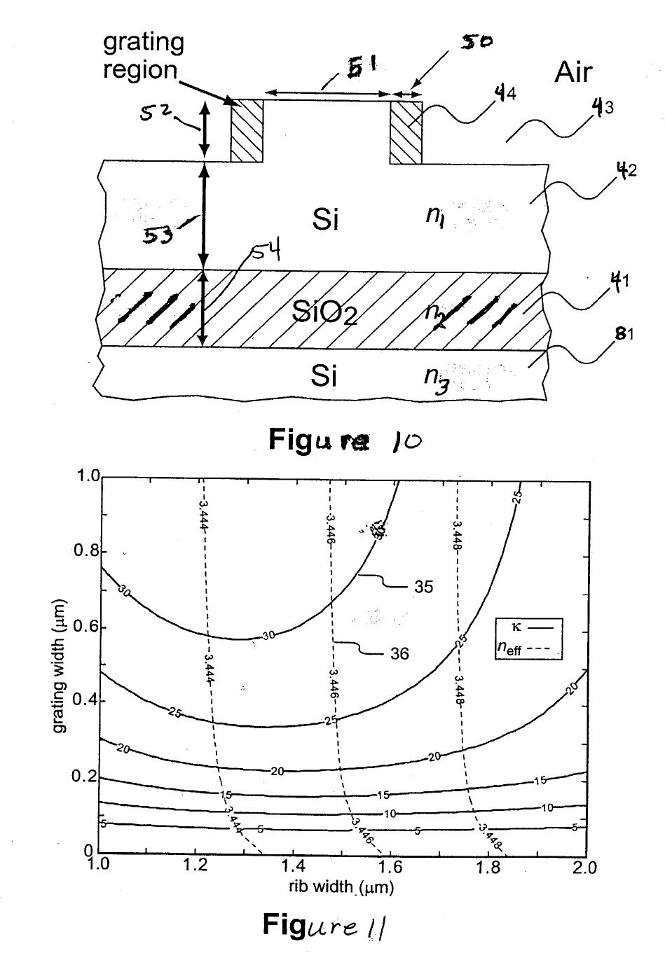

FIGS. 5-9 show additional grating width variations of the optical waveguide from a top view. More specifically, FIG. 5 shows a grating area 120 having variations in the grating period and grating width simultaneously which is often characteristic of dispersion compensating devices. FIG. 6 shows the introduction of two gratings of dissimilar period 121 and 122 on opposite sides of the waveguide. In another example, FIG. 7 shows a grating area 125 having variations in the grating depth characteristic of the sum or product of two periodic functions. FIG. 8 shows a grating area 126 having variations in the thickness of the grating teeth 123 along the grating's length. Lastly, FIG. 9 shows angled, or blazed, gratings 124 which can couple light out of the waveguide.

It is noted that the same variations can be applied to waveguide geometries other than channel geometry.

FIG. 10 illustrates a more detail example of a rib optical waveguide according to the concepts of the present invention. As shown in FIG. 10, the rib optical waveguide includes an air cladding 43 and an apodized reflection filter composed of silicon 42 upon silicon dioxide 41. The apodized reflection filter has a grating region composed of gratings 44. As noted above, the gratings 44 may very in width 50 so as to vary the width 51 of the rib.

In a preferred embodiment of the present invention, the height 52 of the rib is about 0.8 microns, the height 53 of the silicon region 42 is about 1.4 microns, and the height 54 of the silicon dioxide region 41 is about 1.0 micron. Furthermore, in a preferred embodiment of the present invention, the index of refraction n₁ of the silicon region 42 is about 3.48, the index of refraction n₂ of the silicon dioxide region 41 is about 1.46, and the index of refraction n₃ of a silicon region 81, upon which the silicon dioxide region 41 is formed, is about 3.48. In consideration of these preferred values, the rib optical waveguide of FIG. 10 can be used to reflect a 40 Gbit/sec WDM channel from a spectrum of channels spaced apart by 100 GHz.

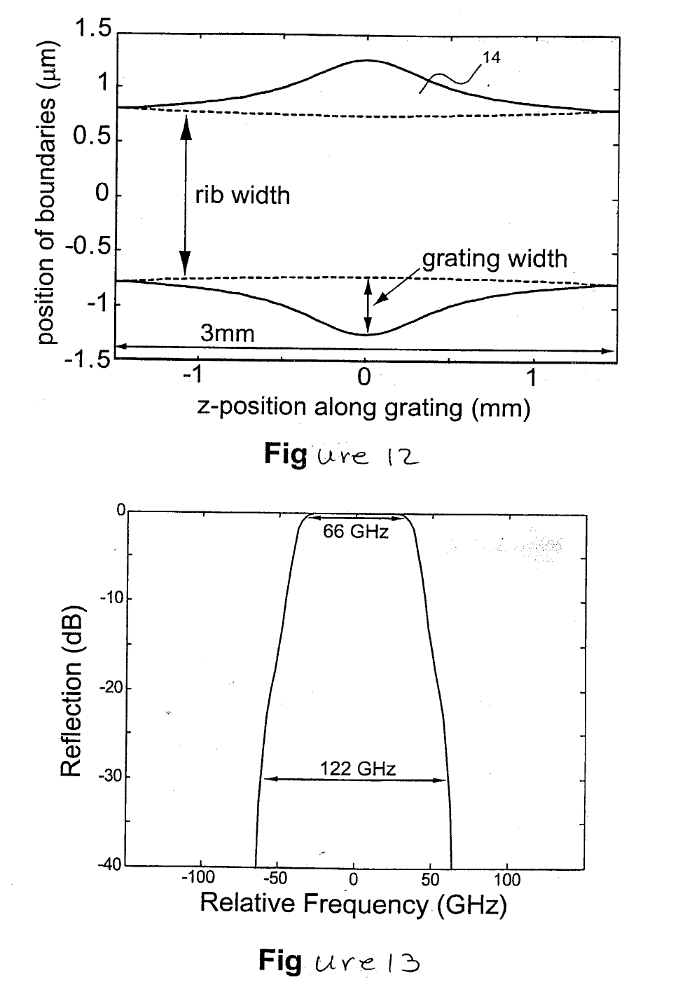

Using the values described above for a rib optical waveguide, according to the concepts of the present invention, FIG. 11 is a graph plotting contours of constant 35 (cm⁻¹) and η_{eff} 36 as a function of waveguide and grating width for the transverse-electric (TE) mode, FIG. 12 plots the extent and placement of the grating region 14 as a function of position along the waveguide, and FIG. 13 plots the calculated reflection spectrum for the waveguide's TE mode.

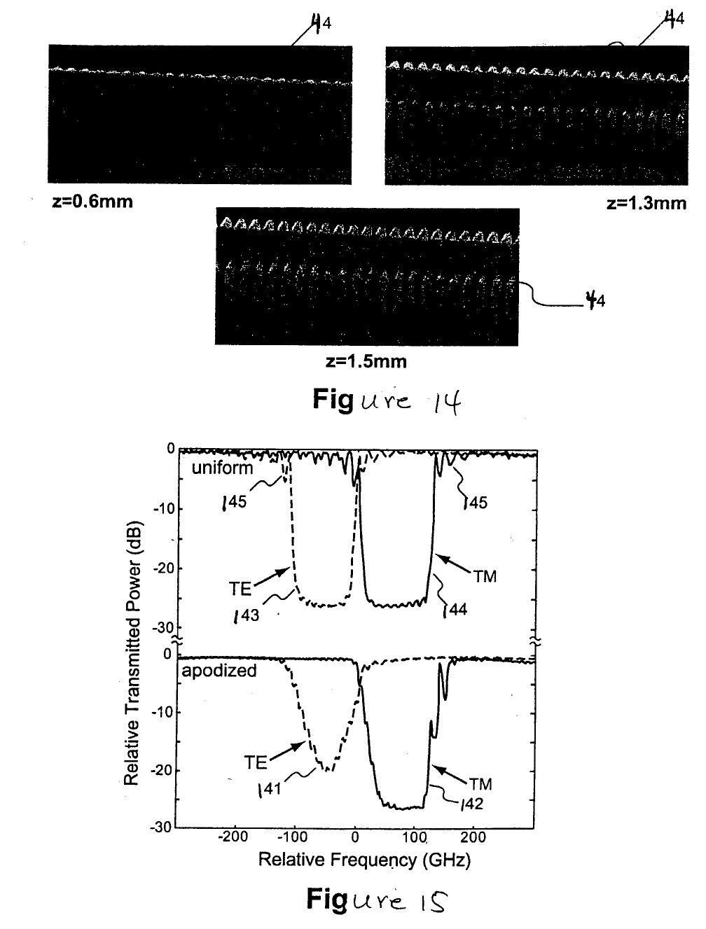

FIG. 14 shows three scanning-electron micrographs at different points along the grating corresponding to different grating strengths for a rib optical waveguide constructed as illustrated in FIG. 10 and having the preferred values described above. FIG. 15 shows the measured transmission response of the grating for the transverse-electric (TE) 141 and transverse-magnetic (TM) 142 modes compared to the transmission response 143 and 144 of a similar-bandwidth device without apodization. The elimination of transmission side lobes 145 in the apodized device is clearly evident.

The present invention has been described above, and will be further described below in terms of an exemplary rib waveguide structure. This particular structure is formed in a silicon-on-insulator (SOI) materials system by appropriately masking and etching a core silicon region 42 as illustrated in FIG. 10. It will be evident to one skilled in the art that the same design considerations and fabrication techniques will be applicable to other waveguide geometries, e.g. channel, as illustrated in FIG. 3, waveguides, and other materials systems, e.g. semiconductors formed from columns III and V of the periodic chart or doped silicon-dioxide.

It is further noted that although the present description is directed to the structure and fabrication of a narrow-bandwidth reflection filter, non-uniform sidewall-grating structures can provide other functions as well.

Below is a more detailed explanation of the usefulness of sidewall-gratings in silicon-on-insulator (SOI) rib waveguides. Though opaque at visible wavelengths, silicon exhibits low absorption at the telecommunications wavelengths near 1550 nm. As shown in FIG. 10, light is confined vertically by the silicon-dioxide layer 41 below and air 43 above, and confined laterally within the etched rib of silicon region 42.

Single-mode SOI channel waveguides typically have a thickness on the order of 200 nm because of the high refractive-index contrast between silicon and silicon dioxide. Alternatively, rib waveguides can remain single-moded even with much larger dimensions. Larger rib waveguides typically exhibit lower propagation losses and fiber-coupling losses.

Once a suitable waveguide geometry is selected, according to the concepts of the present invention, the waveguide effective-index, η_{eff}, and coupling constant, , for a range of waveguide widths and grating widths are calculated. The coupling constant, , describes how rapidly power is coupled from the forward propagating mode to the corresponding backward propagating mode. In a preferred embodiment, a semi-vectorial finite-difference eigenmode solver can be used to calculate these parameters, and interpolate to find the contours of constant η_{eff} 36 and 35 as shown in FIG. 11.

In this example, is varied while η_{eff} is maintained constant. Thus, a contour of constant η_{eff} is selected and waveguide and grating widths are chosen to provide the desired at each point along the grating.

This exemplary device, as illustrated in FIG. 10, operates at telecommunications wavelengths near 1550 nm, and the nominal effective-index of the waveguide is 3.446. The grating period is given by =0/(2 η_{eff})=224.9 nm. The desired filter response dictates the apodization function (z)=0 cos²(z/L) where−L/2<z<L/2, L=3 mm, and 0=28 cm⁻¹. FIG. 12 plots the boundaries of the waveguide rib and grating regions of this example. Note that the waveguide narrows slightly as the grating width increases. This is a direct result of the desire to maintain a constant η_{eff}.

The calculated power-reflection spectrum of the device is shown in FIG. 13. It is centered at 1550 nm and has a reflection bandwidth greater than 60 GHz at −0.5 dB. The bandwidth remains narrower than 130 GHz at −30 dB. These bandwidth specifications insure minimal transmission of the filtered channel, and minimal reflection of the adjacent channels.

Unlike like the waveguide-grating structure depicted in FIG. 5, this device does not require that the grating period or phase change along the length of the grating. Additionally, this device could be designed to reflect multiple wavelength bands using the structures similar to those shown in FIGS. 6 and 7. Although this device was designed with equal thickness grating teeth and spaces, one can exercise additional control over η_{eff} and by varying the duty-cycle as shown in FIG. 8.

To fabricate a preferred embodiment of the optical waveguides of the present invention, the fabrication process begins with silicon-on-insulator wafers from a commercial ELTRAN (Epitaxial Layer TRANsfer) process available from Canon™.

As shown in FIG. 10, these wafers consist of a silicon substrate 81, a thermally grown silicon-dioxide layer 41, and an epitaxially grown and bonded silicon core layer 42. The SOI wafers are spin coated with a 125 nm thick layer of hydrogen-silsesquioxane (HSQ), commercially available as FOx™ (Flowable Oxide) from Dow Corning™. The HSQ serves as a high-resolution, negative-tone, electron-sensitive resist.

The waveguide-grating pattern is exposed by scanning electron-beam lithography, and the HSQ is developed in a tetra-methyl ammonium hydroxide solution. The patterned HSQ serves as a mask for chlorine-based reactive-ion etching of the silicon waveguide-grating structure.

After fabrication, the waveguide facets are cut and polished and the transmission spectrum can be measured using a tunable laser, lensed optical fiber, and photo-diode detector. As shown in FIG. 15, transmission spectra for the TE 141 and TM 143 modes of a typical device with non-uniform sidewall gratings are plotted. These spectra are compared to the TE 143 and TM 144 transmission spectra of a similar bandwidth device using uniform gratings. As intended, the side lobes 145 in the spectrum are greatly reduced in the device with non-uniform gratings.

It is noted that in the various descriptions above, the gratings are placed on both sides of the waveguides; however, the concepts of the present invention also contemplate the placing of gratings on only one side of the waveguide. It is further noted that the placing the grating on both sides of the waveguide allows a greater maximum grating strength for a given geometry.

The various physical structures described above can be formed by any of a number of fabrication techniques. These include, but are not limited to, the following:

1. A mask, containing both the central waveguide-region and the adjacent grating teeth, is defined on top of the core material. The mask pattern is transferred into the core by a suitable etching process. After removing the masking layer, an upper-cladding layer can be deposited over the core if desired.

2. A mask, containing both the central waveguide-region and the adjacent grating teeth, is defined on top of the lower-cladding material. The mask pattern is transferred into the lower-cladding by a suitable etching process. After removing the masking layer, the core is “backfilled” into the lower-cladding and then the upper-cladding is deposited.

3. A mask, containing both the central waveguide-region and the adjacent grating teeth, is defined on top of the upper-cladding material. The mask pattern is subsequently transferred into the upper-cladding by a suitable etching process.

4. The core is formed from a photon, electron, ion, or neutral atom sensitive material that can be patterned into the desired waveguide-grating geometry by lithographic techniques. This may include materials whose refractive index changes upon exposure, or whose solubility in certain chemicals changes.

5. The core is selectively grown on a masked lower-cladding layer by any of a number of materials deposition techniques.

The various configurations of the present invention, as presented above, provide an optical device containing non-uniform gratings in an optical waveguide. The grating is placed in the sides of the waveguide during the same planar processing step used to form the waveguide itself. Such a device eliminates the various difficulties of placing non-uniform gratings in the top or bottom of a planar waveguide. As a result, higher performance devices can be realized in fewer fabrication steps.

While various examples and embodiments of the present invention have been shown and described, it will be appreciated by those skilled in the art that the spirit and scope of the present invention are not limited to the specific description and drawings herein, but extend to various modifications and changes all as set forth in the following claims.

What is claimed is:

1. An integrated optical device, comprising:
a substrate;
a waveguide formed on said substrate;
said waveguide having a width that varies non-uniformly along a direction of light propagation.

2. The device as claimed in claim 1, wherein said width of said waveguide width varies symmetrically according to a functional form.

3. The device as claimed in claim 2, wherein said functional form is a product of a periodic function and aperiodic function.

4. The device as claimed in claim 3, wherein said periodic function is sinusoidal.

5. The device as claimed in claim 3, wherein said periodic function is square-wave.

6. The device as claimed in claim 3, wherein said periodic function is saw-tooth.

7. The device as claimed in claim 3, wherein said aperiodic function is truncated raised cosine.

8. The device as claimed in claim 3, wherein said aperiodic function is Gaussian.

9. The device as claimed in claim 3, wherein said aperiodic function is triangular.

10. The device as claimed in claim 1, wherein said width of said waveguide varies symmetrically according to a functional form comprising the sum of two periodic functions and an aperiodic function.

11. The device as claimed in claim 1, wherein said width of said waveguide varies symmetrically according to a functional form comprising the sum a periodic function and two aperiodic functions.

12. The device as claimed in claim 1, wherein said width of said waveguide varies symmetrically according to a functional form comprising the sum of a periodic function and an aperiodic function.

13. The device as claimed in claim 1, wherein said width of said waveguide varies symmetrically according to a functional form comprising the product of two periodic functions and an aperiodic function.

14. The device as claimed in claim 1, wherein said width of said waveguide varies symmetrically according to a functional form comprising the product of a periodic functions and two aperiodic functions.

15. The device as claimed in claim 1, wherein said width of said waveguide varies asymmetrically.

16. The device as claimed in claim 1, wherein said width of said waveguide varies asymmetrically such that each side of the waveguide is described by a different functional form.

17. The device as claimed in claim 1, wherein said width of said waveguide width varies symmetrically according to a functional form such that the period of the functional form changes along the direction of propagation.

18. The device as claimed in claim 1, wherein said width of said waveguide width varies symmetrically according to a functional form such that the phase of the functional form changes along the direction of propagation.

19. The device as claimed in claim 1, wherein said width of said waveguide width varies symmetrically according to a functional form such that the period and the phase of the functional form changes along the direction of propagation.

20. A wavelength selective filter, comprising:
a waveguide having a width that varies non-uniformly along a direction of light propagation.

21. The wavelength selective filter as claimed in claim 20 being a passive wavelength selective filter.

22. The wavelength selective filter as claimed in claim 20 being an active wavelength selective filter.

23. The wavelength selective filter as claimed in claim 20 being a tunable wavelength selective filter.

24. A pulse shape-matching filter, comprising:
a waveguide having a width that varies non-uniformly along a direction of light propagation.

25. A dispersion compensator, comprising:
a waveguide having a width that varies non-uniformly along a direction of light propagation.

26. A laser feedback structure, comprising:
a waveguide having a width that varies non-uniformly along a direction of light propagation.

27. An optical detector, comprising:
a waveguide having a width that varies non-uniformly along a direction of light propagation.

28. A waveguide-to-waveguide coupler, comprising:
a waveguide having a width that varies non-uniformly along a direction of light propagation.

29. A waveguide-mode coupler, comprising:
a waveguide having a width that varies non-uniformly along a direction of light propagation.

30. A waveguide-to-radiation coupler, comprising:
a waveguide having a width that varies non-uniformly along a direction of light propagation.

31. A method of forming an optical waveguide having a width that non-uniformly varies along a direction of propagation, comprising:
(a) depositing optical waveguide material on a substrate;
(b) creating a mask having a pattern containing a central waveguide-region and adjacent grating teeth, the adjacent grating teeth providing non-uniform varying width of the optical waveguide; and
(c) etching away the optical waveguide material not protected by the mask.

32. The method as claimed in claim 31, further comprising:
(d) forming a cladding layer upon the remaining optical waveguide material and substrate.

33. A method of forming an optical waveguide having a width that non-uniformly varies along a direction of propagation, comprising:
(a) depositing optical waveguide material on a substrate;
(b) creating a mask having a pattern containing a central waveguide-region and adjacent grating teeth, the adjacent grating teeth providing non-uniform varying width of the optical waveguide; and
(c) etching away a portion of the optical waveguide material not protected by the mask so as to form a rib waveguide.

34. The method as claimed in claim 33, further comprising:
(d) forming a cladding layer upon the remaining optical waveguide material.

35. A method of forming an optical waveguide having a width that non-uniformly varies along a direction of propagation, comprising:
(a) depositing photon, electron, ion, or neutral atom sensitive core materials on a substrate; and
(b) exposing the deposited material to the appropriate radiation or particle in a pattern containing a central waveguide-region and adjacent grating teeth, the adjacent grating teeth providing non-uniform varying width of the optical waveguide.

36. The method as claimed in claim 35, further comprising:
(c) removing the exposed deposited material by subsequent chemical processing.

37. The method as claimed in claim 35, further comprising:
(c) removing the unexposed deposited material by subsequent chemical processing.

38. A method of forming an optical waveguide having a width that non-uniformly varies along a direction of propagation, comprising:
(a) depositing photon, electron, ion, or neutral atom sensitive core materials on a substrate; and
(b) exposing the deposited material to the appropriate radiation or particle in a pattern containing a central waveguide-region and adjacent grating teeth, the adjacent grating teeth providing non-uniform varying width of the optical waveguide to alter the refractive index of the deposited material.

39. A method of forming an optical waveguide having a width that non-uniformly varies along a direction of propagation, comprising:
(a) depositing photon, electron, ion, or neutral atom sensitive core materials on a substrate;
(b) creating a the pattern containing a central waveguide-region and adjacent grating teeth, the adjacent grating teeth providing non-uniform varying width of the optical waveguide in a dopant material; and
(c) diffusing the patterned dopant into the deposited material.
